(19) United States
(12) Patent Application Publication
(10) Pub. No.: US 2005/0226169 A1
(43) Pub. Date: Oct. 13, 2005

(54) Dynamic identification of nodes in a network

(76) Inventors: Richard Andrews Kelsey, Arlington, MA (US); Matteo Neale Paris, Concord, MA (US)

Correspondence Address: FISH & RICHARDSON PC, P.O. BOX 1022, MINNEAPOLIS, MN, 55440-1022, US

(21) Appl. No.: 11/062,515

(22) Filed: Feb. 22, 2005

Related U.S. Application Data
(60) Provisional application No. 60/546,020, filed on Feb. 19, 2004.

(51) Int. Cl. H04L 12/28

(52) U.S. Cl. 370/254; 370/400

(57) ABSTRACT

A method for identifying nodes in a network includes selecting identification parameters for the nodes in the network. At some nodes in the network, identification information is maintained for a plurality of nodes based on messages received from neighboring nodes, and the identification information is monitored for a conflict between two or more nodes.

### CROSS-REFERENCE TO RELATED APPLICATIONS

This application claims the benefit of U.S. Provisional Application No. 60/546,020, filed Feb. 19, 2004, incorporated herein by reference.

### BACKGROUND

This invention relates to dynamic identification of nodes in a network.

Wireless ad-hoc networks, which are typically self-organizing and which pass packets over multi-hop paths through the network, have been applied to a variety of applications. Various routing algorithms have been proposed for such networks, including Ad Hoc On-Demand Distance Vector Routing (AODV) and Dynamic Source Routing (DSR), in which packets are forward from node to node on a particular path from an origin node to a destination node. Another type of routing, called Gradient Routing, forwards packets without identifying each successive node in a path as a packet is retransmitted at intermediate nodes in the network. Nodes in such networks are typically identified by manually assigned node identification numbers.

### SUMMARY

In one aspect, in general, the invention features a method, and an associated apparatus and software, for identifying nodes in a network. Identification parameters are selected for the nodes in the network. At some nodes in the network, identification information is maintained for a plurality of nodes based on messages received from neighboring nodes, and the identification information is monitored for a conflict between two or more nodes.

The method can includes one or more of the following features.

Selecting identification parameters includes: generating a random number at a first node in the network, broadcasting the random number to a plurality of nodes in the network, and selecting the identification parameter based on the random number. The method can also include receiving the broadcast random number, and reporting a conflict if the broadcast random number is already in use.

Selecting identification parameters includes: generating a random number at a first node in the network, sending a request message from a second node in the network to the first node, selecting the identification parameter based on the random number in response to the request message, and sending the identification parameter from the first node to the second node. Selecting the identification parameter based on the random number can include using the random number as a prefix for the identification parameter.

Maintaining identification information based on messages received from neighboring nodes includes: receiving a message from a neighboring node, the message originating from an origin node, and storing an identification parameter for the origin node along with a tag included in the message.

Monitoring the identification information for a conflict between two or more nodes includes: receiving a message from a neighboring node, the message originating from an origin node, matching an identification parameter for the origin node to a stored identification parameter, comparing a tag included in the message with a stored tag associated with the stored identification parameter, and reporting a conflict if tags do not match.

The tag can be derived from a source local to the origin node, or the tag can be randomly selected.

Aspects of the invention can include one or more of the following advantages:

Automatically assigning node identification numbers is less prone to error than assigning node identification numbers manually. Memory usage and network overhead can be reduced by allowing node identification numbers to be assigned by identification authorities.

Other features and advantages of the invention are apparent from the following description, and from the claims.

### DESCRIPTION OF DRAWINGS

FIG. 1 is a diagram of a wireless network.

FIG. 2 is a diagram of a data packets.

FIG. 3 is pseudocode for a procedure to send a packet from a originating node.

FIG. 4 is pseudocode for a procedure to process a received packet.

FIG. 5 is pseudocode for a procedure to process a received packet at the destination node.

FIG. 6 is pseudocode for a procedure to process a received unicast packet at an intermediate node.

FIGS. 7A-B are pseudocode for a procedure to process a received broadcast packet.

FIG. 8 is a diagram of a wireless network with some nodes linked by a wired network.

FIG. 9 is a diagram of a zoned wireless network.

### DESCRIPTION

1 Gradient Routing Approach

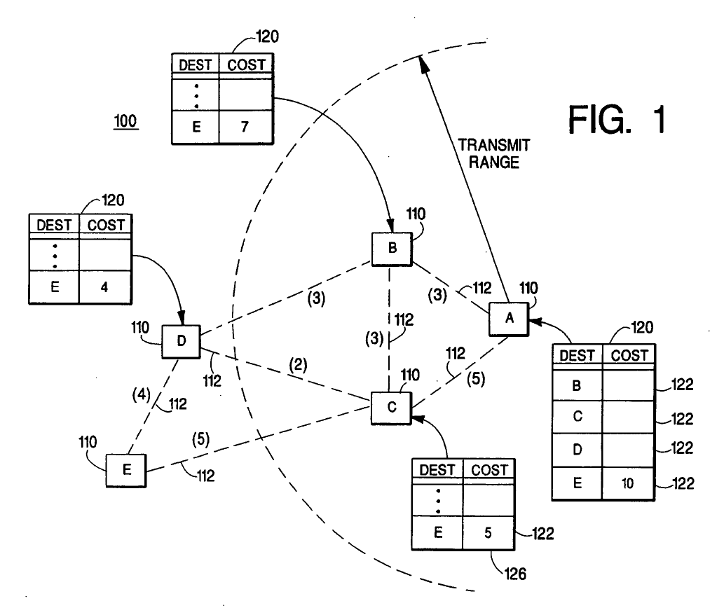

Referring to FIG. 1, a wireless network 100 includes a number of wireless nodes 110. In the example that is shown, nodes 110 are identified as nodes A-E. Not all pairs of nodes can necessarily communicate directly, and therefore data packets that pass through wireless network 100 generally take paths that pass through a number of intermediate nodes in a multi-hop routing approach. Routing of packets in wireless network 100 uses a gradient approach. Furthermore, an originating or intermediate node does not necessarily send each outgoing packet to a particular next node on a route to the ultimate destination for the packet. Rather, nodes transmit packets such that, in general, any of a number of nodes that receive the packet may forward the packet to its destination. As is described further below, the routing approach includes features that reduce the number of transmission needed to pass a packet from an origin node to a destination node.

In wireless network 100 shown in FIG. 1, nodes that are able to communicate directly with one another are indicated by a dashed line 112 joining the nodes. For example, nodes B and C are within node A's transmit range, and therefore can receive data from node A. In the discussion below, connectivity between nodes is generally assumed to be symmetrical (that is, for any pair of nodes, both nodes can receive transmissions from the other, or neither can). However, the version of the routing protocol described below will continue to function correctly in the presence of asymmetric links, as long as any two nodes are connected by a path consisting of symmetric links, and alternative versions of the routing protocol may not require such connectivity.

As part of the routing protocol, each node 110 maintains a cost table 120. Each cost table has a number of records (rows) 122, each row being associated with different particular destination node. Cost table 120 includes two columns: one column 124 identifies the destination, and another column 126 represents a cost of sending a packet from the node maintaining the table to the corresponding destination. The costs are positive quantities that represent that node's estimate of the lowest cost path through the network to the destination. The cost of a path includes additive terms corresponding to each of the links along the path. The cost of a link is inversely related to the link reliability. Reliability of a link can be estimated using any of a variety of techniques. For example, reliability of a link can be estimated by keeping track of the signal-to-noise ratio (SNR) of packets arriving at a node from a neighboring node over that link. In general, shorter links typically have lower cost because of the relatively higher signal strength than longer links. This version of the routing protocol does not rely on the link reliability being estimated as equal at the nodes of the link, and alternative versions of the protocol explicitly account for asymmetrical link reliability.

Any of a variety of physical (PHY) and media access control (MAC) layers may be used. In one implementation, nodes 110 communicate according to a proposed IEEE 802.15.4 standard. A direct sequence spread spectrum (DSSS) communication technique is used in the unlicensed 2.4 GHz ISM (Industrial, Scientific, and Medical) band. Use of spread spectrum communication avoids interference with other communication systems in the same band, including Bluetooth (IEEE 802.15.1) and Wireless LANS using the IEEE 802.11b standard. Alternative PHY and MAC layers that support concurrent transmission of packets from one node to multiple neighboring nodes can be used in an equivalent manner.

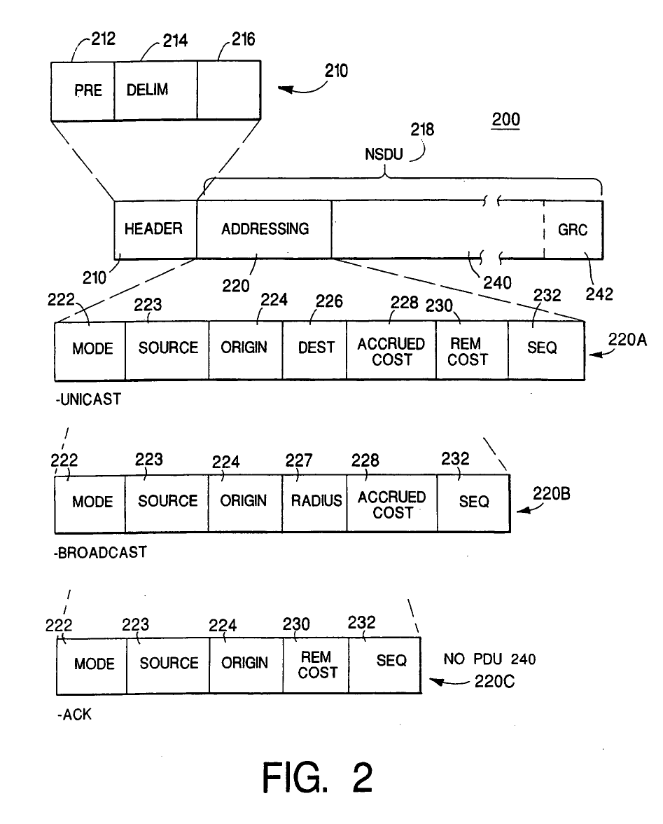

Referring to FIG. 2, data is transmitted between nodes use a packet format in which each packet 200 includes a physical layer header 210 and a remainder of the packet that forms a network service data unit (NSDU) 218. Header 210 includes a preamble 212, which is used for synchronization of the spread spectrum communication, a packet delimiter 214, and a packet length 216. NSDU 218 includes an addressing section 220 and a packet data unit (PDU) 240, as well as an optional CRC 242.

Addressing section 220 includes information that is used for routing packets through the network. Addressing section 220 includes a mode 222, which includes an indicator whether the packet is a unicast packet, broadcast packet, or an acknowledgment packet, and an indicator of whether intermediate nodes should update their cost tables based on this packet. As shown in the lower portion of FIG. 2, in addressing sections 220A-C, the format of the addressing section depends on the mode of packet.

For a unicast packet, addressing section 220A includes an identification of the origin node 224 and the destination node 226 for the packet, a sequence number 232 for packets sent from the origin node and an identification of source node 223 which transmitted the packet on the last link. In this version of the protocol nodes are identified by unique node identification numbers. The node identification numbers are automatically assigned upon entry of a node 110 into the network 100, as described in more detail below in section 5. Addressing section 220 also includes an accrued cost 228 from the origin to the source and a remaining cost 230 from the source to the destination for the packet. The costs are represented as integers in a range 0-255. The procedure for setting the accrued and remaining costs is described further below.

For a broadcast packet, addressing section 220B does not include a destination, but rather includes a radius 227 is used to count the number of hops the packet has taken from its origin. As the broadcast packet is not addressed to a particular destination, the addressing section does not include a remaining cost field.

Addressing section 220C for an acknowledgment packet includes source 223, origin 224, remaining cost 230, and sequence number 232.

### 2 EXAMPLES

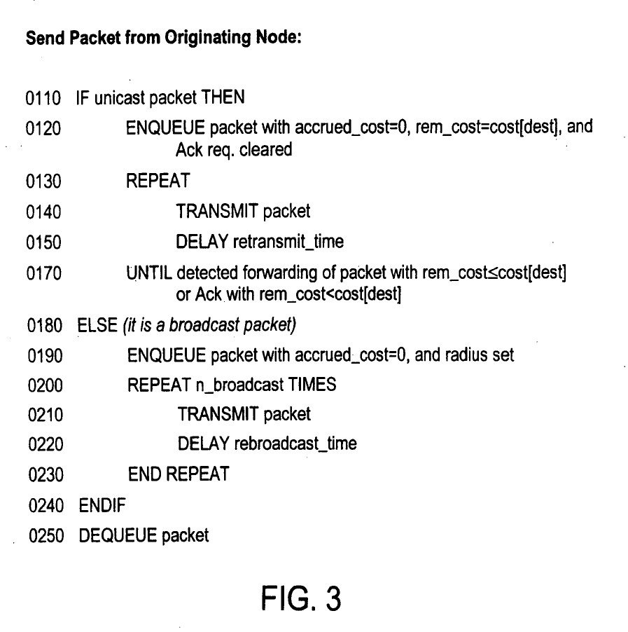

Several examples of packet forwarding according to the gradient routing approach are discussed below with reference to FIGS. 3 to 7A-B. These examples illustrate the procedures that are followed in transmitting and receiving packets. For simplicity, in the discussion below, a single “packet” is associated with a particular origin node and sequence number at that node. When a node is said to receive a packet, or multiple copies of the packet, this means that the node has received an instance of a packet with the particular origin node and sequence number. When important, the various instances (i.e., transmissions or retransmissions) of the packet are distinguished in the discussion. Note also that the procedures shown in FIGS. 3 to 7A-B each relate to processing a single packet. However, each node may concurrently process multiple packets according to the procedures.

### 2.1 Example 1

In a first example, a node A 110 transmits a unicast packet destined for node E 110. The packet is not flagged to update the cost tables as the packet traverses the network. In this example, each node of the network includes an record 122 in its cost table 120 for destination E. For illustration, link costs for the links are indicated in FIG. 1 in parentheses, and the minimum costs in cost table 120 at each node is the minimum total costs along the shortest path to destination E.

Source node A 110 initializes addressing section 220 of packet 200A destined for node E with its own identification in source node 223 and origin node 224 and node E's identification in destination node 226. Node A initializes accrued cost 228 to zero and remaining cost 230 to the cost to destination E retrieved from its cost table 120, which in this example is a cost of 10. This packet is flagged as a unicast packet that is not to be used to update cost tables. Node A increments its packet sequence number and puts that sequence number in sequence number field 232 and enqueues the packet in an outbound packet queue.

Referring to the procedure shown in FIG. 3, the packet is a unicast packet (line 0110) therefore originating node A 110 executes an initial sequence of steps at lines 0120-0170 in the procedure. First, node A passes the packet to a MAC layer for transmission (line 0140). Note that depending on the particular MAC and PHY layer, this step may in fact result in several attempted transmissions, for example, if collisions are detected when individual transmission are attempted.

The MAC layer does not provide a guarantee that the packet has been received by any neighboring node. Therefore, node A waits a retransmission time (line 0150). If before the expiration of the retransmission time, node A has either detected that another node closer to the destination has already forwarded the packet, or has received an explicit acknowledgement that the packet was forwarded by some node close to the destination (line 0170) then the node dequeues the packet (line 0250). As is discussed below, when a node forwards the packet, it re-writes the remaining cost field 230. By examining this field, node A can determine whether the node has indeed been forwarded by a closer node to the destination than itself. Similarly, explicit acknowledgement packets include a remaining cost field which is used for the same purpose. Node A repeats the steps of transmitting the packet and waiting (lines 140-150) until it detects the suitable forwarding or acknowledgment, or a retry limit is reached.

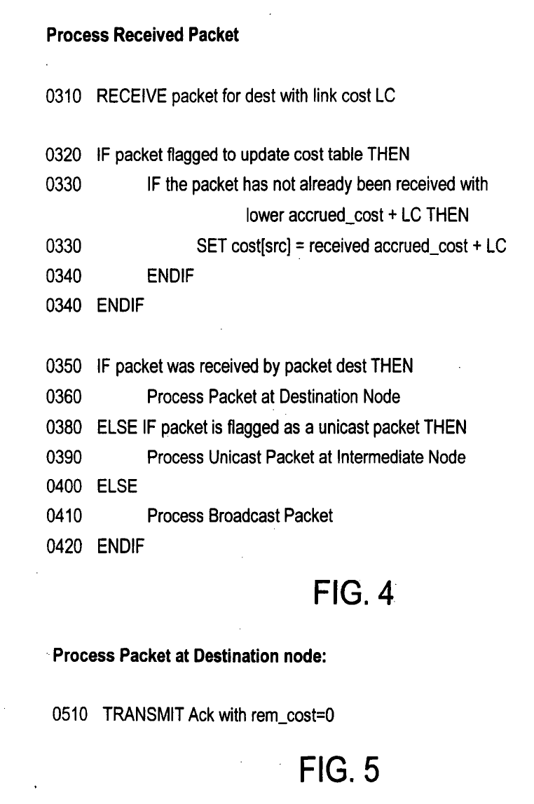

In this example, nodes B and C are in range of transmission from node A and both receive the packet. Referring to the procedure shown in FIG. 4, each node receives the packet and measures the received SNR, averaging it with SNR values previously detected from node A. The SNR is used to determine the link cost, LC. In this version of the system, the link cost is set to an integer in the range of 1 to 7.

If the packet is flagged to update the cost tables at receiving nodes (line 0320), the receiving node may update its cost table based on the cost of the reception. This updating procedure and the circumstances under which the node updates its cost table are discussed further below. In this example, the packet from node A is not flagged to update the cost tables and nodes B and C are not the ultimate destination of the packet and therefore processing of the receiving packet at each of nodes B and C continues at line 0350 with execution of the procedure to process a unicast packet at an intermediate node (line 0390).

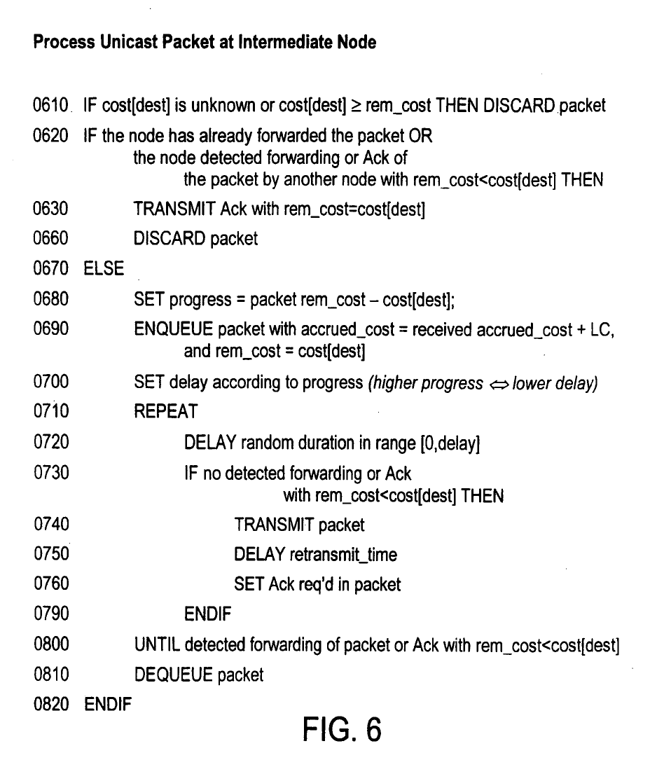

Referring to the procedure shown in FIG. 6, each intermediate node (i.e. nodes B and C in this example) that receives a packet first determines whether it should forward (retransmit) the packet, and if so delays retransmitting the packet for a period of time that depends on how much “progress” toward the ultimate destination the packet has made on its last transmission. Specifically, processing of the received unicast packet begins with a check to see if the receiving node has an entry in its cost table with the remaining cost to the destination of the received packet (line 0610). If the node does not have an entry, the node discards the packet without forwarding it. If it does have an entry, but its entry for the destination indicates that it is farther from the destination than the previous transmitter of the packet, then the node also discards the packet. In this example, both node B and node C are have lower remaining cost to destination E than is indicated in the received packet, and therefore neither discards the packet.

At this point in the example, on receiving the first transmission of the packet, neither node B nor node C has already forwarded the packet nor detected another node acknowledging the packet (line 0620) therefore processing of the received packet continues at line 0680.

Next each node computes the progress of the packet on its last hop (line 0680). The progress is defined as the difference between the remaining cost indicated in the received packet and the remaining cost in the cost table of the node computing the progress. A packet that has traveled on a higher cost link will in general have a higher computed progress. The progress of a packet is generally related to the cost of the reception on the last link (i.e., greater progress for lower SNR is typically corresponding to a longer distance), although due to variation in signal characteristics or dynamic changes in the cost tables, the progress is not necessarily equal to the last link cost.

Having computed the progress, nodes B and C then both enqueue the packet (line 0690). The accrued cost in the enqueued packet is incremented according to the last link cost, and the remaining cost is set equal to the node's entry in its cost table for the ultimate destination of the packet. Note that because the accrued cost is not actually used for routing decisions, updating the accrued cost is an optional step if the update costs flag is not set.

As introduced above, the packet is typically not transmitted immediately. Rather, each node next independently computes a maximum delay according to the progress made by the packet on the last transmission (line 0720). In this example, node B has a remaining cost of 7 to node E and therefore the progress of the packet, which has the remaining cost set to 10, is 3. Similarly, the progress of the packet at node C is 5. This maximum delay is based on the progress such that generally, the maximum delay is smaller when the progress is larger. This approach generally gives preference to paths with the fewer hops and reduces end-to-end latency. Note that nodes B and C do not have to coordinate their retransmission of the packet, and neither is necessarily aware that the other has also received and can forward the packet.

Each of the intermediate nodes B and C next performs a loop (lines 0710-0800) that is similar to the steps executed by the originating node (see lines 0130-0170 in FIG. 3). However, before transmitting the packet for the first time the node waits a random delay that is chosen from a uniform probability distribution ranging from zero to the maximum delay that was computed according to the progress of the packet. In this version of the system, the maximum delay is set equal to ½ to the power of the computed progress (typically in the range 1 to 7) times a fixed time constant, here 24 ms. Therefore, the maximum delay at node C with progress 5 is 0.75 ms., while the maximum delay for node B with progress 3 is 3.0 ms.

In this example, we assume that the actual delay for node C, which is chosen randomly, is indeed smaller than the chosen delay for node B. Therefore node C executes the test at line 0730 before node B to check whether it has detected any other node forwarding or acknowledging the packet. Because node C has not detected such a forwarding or acknowledgment, it transmits the packet (line 0740) and begins to wait for one retransmission time (line 0750) before determining whether to proceed with further retransmissions.

When node C forwards the packet, under the assumption that node B's chosen delay is longer than node C's, node B is still waiting to do so (line 0720). We assume that node B is in range to detect node C's forwarding of the packet. Therefore, at the end of the delay when node B would have transmitted the forwarded packet, it has detected the forwarding by node C. The remaining cost in that detected forwarding from node C is 5, the cost entry in node C's cost table for destination E. Because node B's entry for destination E is 7, which is greater than 5 (line 0750) node B is aware that a closer node to the ultimate destination has already forwarded the node, and that therefore it does not have to.

Returning to originating node A, and referring again to FIG. 3, we assume that node A detects node C's forwarding of the packet, and that the forwarded packet is transmitted by node C while node A is still in its retransmission delay (line 0150). Because the remaining cost in the forwarded packet is 5, which is less than node A's cost to the destination of 10 (line 0170) node A next dequeues the packet (line 0250).

Following the packet to its ultimate destination at node E, we assume that the destination node E, as well as other intermediate nodes A, B, and D are within range of node C's forwarding of the packet. Referring to FIG. 4, destination node E processes the packet transmitted from node C according to the illustrated procedure. In this example, the packet is not flagged to update costs, and therefore node E executes the Process Packet at Destination Node procedure (line 0360), which is illustrated in FIG. 5.

Referring to FIG. 5, this is the first time that node E has received this packet (line 0510), therefore node E immediately transmits an acknowledgement packet, with the remaining cost set to zero.

Nodes A and B each receive the packet forward by node C. However, both of these nodes have costs to node E that are greater than node C, and therefore both nodes discard the detected forwarded packet (line 0610, FIG. 6).

Node D receives the packet forwarded by node C. Node D has not detected the packet being forwarded by a closer node (line 0620) and therefore may need to forward the packet. Node D's cost to node E is 4, one less than the cost from node C, and therefore the progress is 1 (line 0680). The progress is relatively small, so the delay is relatively large (line 0700). Therefore, by the time that delay has expired (line 0720), node D has detected the acknowledgement packet sent by node E, with the remaining cost of zero, which by necessity is less than node D's cost to node E (line 0730). The packet node D received from node C does not indicate than an acknowledgment is required (line 0770) and therefore node D next dequeues the packet (line 0810).

At this point, in this example the packet has traversed from node A through node C to node E, without any unnecessary transmissions

### 2.2 Example 2

In the first variant of Example 1, we assume that node E actually managed to receive node A's original transmission, for example, because of a momentarily favorable transmission environment. We also assume that node E transmits an acknowledgement (line 0520, FIG. 5), but only nodes C and D detect the acknowledgment, not nodes A and B. Because node B has not received the acknowledgement from node E or any retransmission of the packet, node B then transmits the packet at the end of its random delay (line 0740). We assume that B's transmission is received by nodes A, C, and D.

Nodes C and D have already received the acknowledgement for the packet with a remaining cost of zero, and therefore discard node B's forwarded packet. However, because nodes C and D have already received acknowledgement for the packet, each node transmits an acknowledgement packet in response to receiving B's forwarded packet (line 0630). Node B receives these acknowledgments and therefore dequeues the packet (line 0810). Node A receives node B's forwarded packet, and therefore dequeues the packet as having been forwarded (line 0250).

### 2.3 Example 3

In a second variant of Example 1, node D receives node A's original transmission along with nodes B and C. Node D then forwards the packet before the other nodes and this forwarded packet is received by B, C, and E. Therefore nodes B and C do not forward the packet. We assume that node E's acknowledgment is received by nodes B, C, and D, but not by the originating node A. Therefore, at the end of the delay of the retransmission time (line 0150), node A does not know that the packet has made it to its destination, or that it has even been transmitted one hop. Therefore node A retransmits the original packet (line 0140).

When nodes B and C receive the retransmitted packet, they have already received the forwarded packet from node D with a lower remaining cost (line 0620, FIG. 6). Therefore nodes B and C transmit acknowledgments each indicating that node's cost to destination E in remaining cost field 230 of the acknowledgment. Node A receives at least one of these acknowledgements, and therefore dequeues the packet.

### 2.4 Example 4

Next consider an example of a broadcast packet originating at node A with the update cost flag not set. Referring back to FIG. 2, addressing section 220 of a broadcast packet includes radius field 227 rather than destination field 226. The value of the radius field is set to a positive number by the originating node and decremented by each forwarding node. A node forwards a broadcast packet only if the received value of the radius is greater than 1. Processing of broadcast packets at intermediate nodes differs depending on whether the update costs flag is set mode field 222 of addressing section 220.

Referring to FIG. 3, broadcast packets are first enqueued by the node for transmission indicating the desired radius of the broadcast (line 0190). The node then transmits the packet a predetermined number of time, delaying a fixed rebroadcast time between each transmission (lines 0200-0230) before it is dequeued. The node does not need to wait to detect the packet being forwarded. In this version of the system, the node rebroadcasts the packet three times (n_broadcast=3).

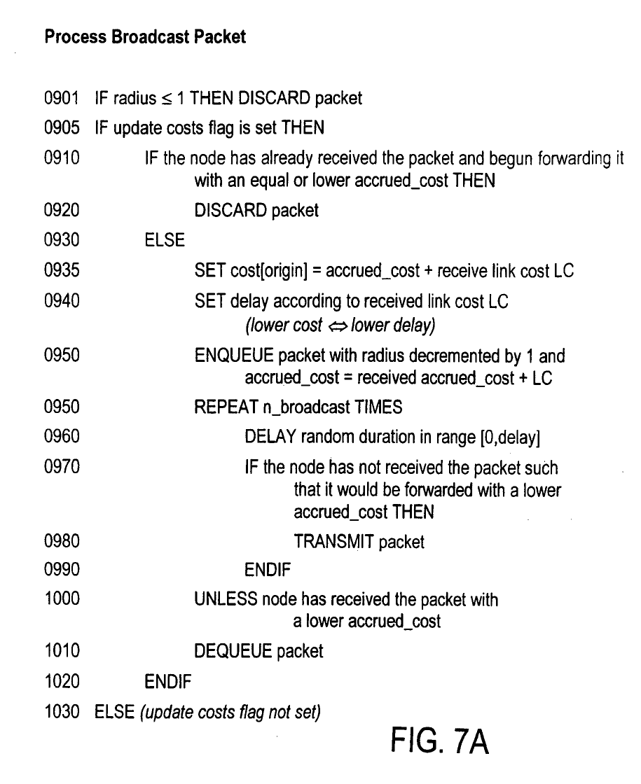

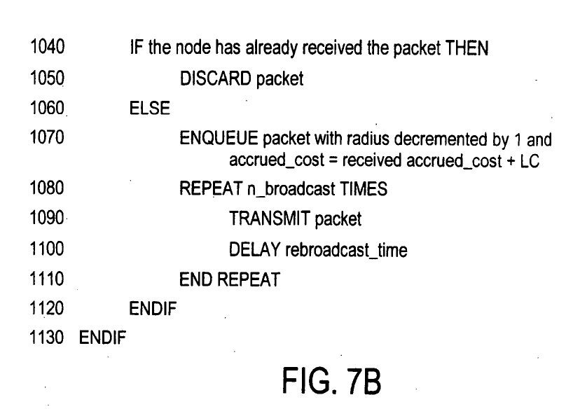

Each receiving node processes the packet according to the procedure shown in FIG. 7A. In general, nodes forward broadcast packets with a received radius greater than 1 after incrementing the accrued cost in the packet by the link cost of the link on which the packet was received and decrementing the radius by 1. The method of handling the packet depends on whether the update costs flag is set.

In this example, when nodes B and C each first receive the packet, because received radius is greater than 1 and the update costs flag is not set processing starts at line 1040. Nodes B and C have not previously received a copy of this packet, therefore both enqueue the packet after incrementing the accrued cost and decrementing the radius (line 1070) and initiate a loop (lines 1080-1110) retransmitting the packet. After forwarding the packet the fixed number of times, each node dequeues the packet.

Node D first receives the forwarded packet from one of nodes B and C first, and initiates the same forwarding procedure. When it receives the forwarded packet from the other of nodes B and C, it discards the packet (line 1050).

### 2.5 Example 5

Next consider an example in which a broadcast packet sent from originating node A with the update costs flag set. The procedure carried out by originating node A is as in the case when the update cost flag is set in Example 4.

In this example, when nodes B and C each first receives the packet, because received radius is greater than 1 and the update costs flag is set processing starts at line 0910. Nodes B and C have not previously received a copy of this packet, therefore processing continues at line 0935.

Each node updates its cost table for the cost of sending a packet from that node to the origin based on the received link cost plus the accrued_cost from the origin node (line 0935). In this example, on this reception, the accrued cost in the received packets from node A at nodes B and C is zero, and therefore nodes B and C both set their cost to A to be the received link cost of the packet just received from node A.

Each receiving node sets a delay according to the received link cost. Recall that the link cost is computed based on the signal characteristics of the transmission, and in this version is quantized to integer values from 1 to 7, with lower cost corresponding to a more reliable link. In this version of the system, the maximum delay is set to the cost minus 1 times a time constant of 4 ms. (line 0940). Therefore, delay for a cost of 1 is equal to 0 ms. while the delay for a cost of 7 is equal to 24 ms. Each node enqueues the packet (line 0950) and then waits for a random duration chose from a uniform distribution in the range from zero to the computed delay (line 0960).

During the process of forwarding a broadcast packet, the node may receive another copy of the packet. That second copy may have a different accrued cost indicated, and the link cost may be different than the first. In this version of the routing approach, if the node would forward the second copy with a lower accrued cost than the forwarding of the previous packet, the forwarding of the previously received copy of the packet is aborted if it has not already been completed. If the second copy would be forwarded with a higher or equal accrued cost, the packet is not forwarded. For example, if the node first receives the packet with an accrued cost a₁ with a link cost of c₁, forwarding of the packet indicates an accrued cost of a₁+c₁. If later, the node receives another copy of the broadcast packet which indicates an accrued cost of a₂ with a link cost of c₂, then that packet would be forwarded indicating an accrued cost of a₂+c₂. But if a₂+c₂≦a₁+c₁, then not only would the neighboring nodes have already received the packet, the second accrued cost from the origin node would be no lower and therefore the second copy of the packet is not forwarded.

Returning to the specific procedure illustrated in FIG. 7A, if at the end of the delay, an intermediate node has not received a copy of the packet that would be forwarded with a lower accrued cost (equal to the received accrued cost plus the link cost) (line 0970) it transmits the packet (line 0980). This delay and transmission is repeated for a predetermined number of times, in this version of the system, three times.

In this example, assume that node B receives the packet with cost 3 and node C receives the packet with cost 5. The maximum delay for node B is therefore 8 ms. while the maximum delay for node C is 16 ms. Assume that based on the randomly chose durations, node B forwards the packet first (line 0980) and node C receives the forwarded packet.

In this example, node C receives the second copy of the packet from node B with a cost of 3 and an accrued cost of 3 indicated in the packet. Therefore the new accrued cost of the packet if node C were to forward it is 6. But node C already has the packet queued with an accrued cost of 5, and therefore node C discards the packet from node B (line 0920).

Note that in principle, a unicast packet can also be sent with the update flag set. The result is that the cost entries for the origin node at a set of nodes “near” the shortest route to the destination are updated.

3 Layered Protocols

The routing approach described above does not guarantee delivery of packets to their destination. Higher level protocols built on top of the network layer are responsible for features such as end-to-end acknowledgements it they are needed by an application. For example, request for an end-to-end acknowledgement may be included in the NPDU 240 (FIG. 2). When the ultimate destination of a unicast packet receives the packet, higher level protocol layers generate an acknowledgment packet for sending back to the origin.

At layers above the network layer, which is responsible for routing, a concept of a session is supported. If in the example network shown in FIG. 1, if node A wishes to communicate with node E, but it does not know the cost to send packets to E, or its cost is out of date, node A sends a broadcast packet that indicates that nodes should update their costs (to node A) when receiving the packet. The payload of the packet also includes a request of node E to establish a session. Node E in response to the request sends a unicast packet back to node A. This packet also has the update flag set. When node A receives node E's reply, the cost tables along the route support bi-directional communication between nodes A and E. As an alternative, node E's reply to node A is also a broadcast packet, thereby updating the cost to node E at a greater number of nodes of the network.

4 Alternatives

4.1 Routing Layer and MAC Layer Interaction

The MAC layer accepts one packet at a time for transmission, and returns a status code upon completion (either successful transmission or failure, for example, maximum CSMA back off reached). When transmitting a packet from the originating node, the MAC layer is allowed to transmit immediately. When transmitting a packet at an intermediate node, the MAC layer is instructed to select an initial random back off in order to avoid transmitting simultaneously with neighboring nodes. The initial backoff is treated independently of the progress-based forwarding delay. A useful, though not necessary, feature of the MAC is the ability to cancel a previously requested transmission. This feature is used by the routing layer to reduce unnecessary transmissions, for example, if an acknowledgement is heard for the packet being processed by the MAC (e.g., avoiding transmission at line 0740 if an acknowledgment is detected at line 0730).

4.2 Cost Averaging

In the cost updating approach described above, a node computes the received link cost based on the received signal-to-noise ratio of a single packet that is flagged to update costs. As an alternative, each node maintains a longer-term average of the cost of receiving packets from its neighboring nodes, and uses this average when it receives a packet flagged for it to update is cost table and to increment the accrued cost field of forwarded packets.

4.3 Proactive Cost Table Updates

Nodes can optionally exchange cost table information with their neighboring nodes, and use the received cost tables and received link costs to update their own tables. For example, rather than waiting for a packet with the update flag set to update an entry in its cost table to the origin node of that packet, the node receives one or more entries of a neighboring node's cost table. The receiving node adds the link cost for packets from the node that sent the entries to each of the costs in the entries. It then replaces any of the costs in its table for which the incremented received costs are lower.

4.4 Unidirectional Costs

In the cost update approaches described above, the cost at an intermediate node B for transmitting a packet to node A is set based on the accrued cost of sending packets from node A to node B. In systems in which the cost of transmitting packets is not symmetrical, an alternative approach may be desirable. Asymmetrical costs can occur for a number of reasons, including differences in transmission power at different nodes, or interference that is localized and affects different receivers to different degrees.

In this approach, each node periodically broadcasts a message with its radius field set to 1 that is received by its neighbors. Because the radius is set to 1, this message is not forwarded by these nodes. The message body includes a cost of receiving packets from each of the neighbors based on previous messages sent from those neighbors.

Each node maintains a table of link costs of receiving a packet transmitted by it at each of its neighbors. When a node B receives a packet from a node A that is flagged with the update costs flag, rather than adding the cost of the reception of that packet to the accrued cost indicated in the packet, it adds the cost of receiving packets at node A from node B from its table.

With this change in the update to the accrued cost, the cost table truly reflects the unidirectional cost of sending a packet to the destination node.

4.5 Communication Backbones

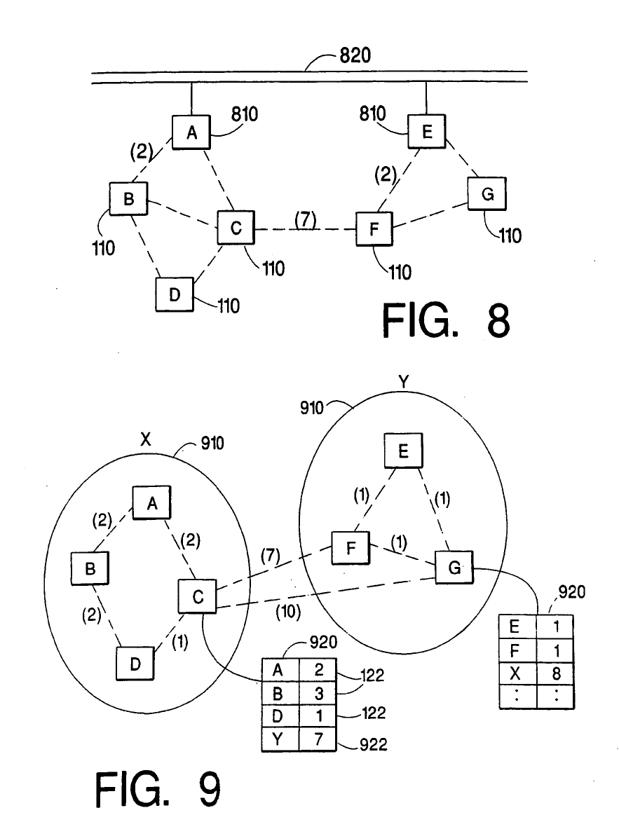

In an alternative approach, nodes may be linked by non-wireless links. For example, referring to FIG. 8 nodes A and E 810 include both a wireless and a wired interface and are linked by wired network 820, such as an Ethernet, MODBUS®, or a dedicated wired link. In the system, the routing and cost update algorithm described above functions as before, with the cost of communicating over the wired links being zero (or smaller than the cost of the wireless links). That is, at node A the costs in the cost table to communicate with node E is zero. In the example shown in FIG. 8, the cost of reaching node F from node E is 4 (B→A=2, A→E=0, E→F=2). When node B transmits a packet to destination node F, and this packet is received by nodes A, C and D, nodes A and C queue the packet for retransmission. Node A is cost 2 from node F so it is likely to retransmit first, which it does by passing the packet over wired network 820.

Note that should the wired network fail, connectivity between nodes B and F is maintained via the link between nodes C and F. In this way, a wireless network can serve as a backup for other nodes linked by a wired network.

4.6 Service Addressing and Service Discovery

In the approaches described above, addressing is according to identities of nodes in the network. In an alternative approach in which each node can host one or more of services, and packets are addressed to services rather than to nodes. Furthermore, the same service may be hosted at a number of different nodes. In this alternative, cost tables include entries that identify costs to send packets to the particular services. The routing algorithm then functions as described above. When a node needs a particular service, it sends a broadcast packet to that service, and a node listing that service replies, thereby locating the nearest node hosting the service.

4.7 Zoned Addressing

In another approach, nodes are arranged in zones. For example, part of a node identification (e.g., a prefix of a numerical address) may identify the zone that the node is a member of. In such an approach, a node may not explicitly maintain a cost to every possible destination node. Referring to FIG. 9, nodes A, B, C, and D are in a zone X 910, while nodes E, F, and G are in zone Y 910. Each node maintains a cost table 920, which includes records 122 that are associated with individual nodes in its zone, and also includes records 922 that are each associated with an entire zone. The cost associated with a zone is the minimum cost to any node in that zone.

The routing algorithm and cost update algorithm described above functions similarly, with an entry in a cost table for a zone reflecting the minimum cost to a node in that zone. That is, when a node wants to transmit a packet to a node in another zone, it uses the node's identification to determine that node's zone identification, and looks up the record in the cost table according to the zone identification.

In another variant of this approach, there may be multiple level hierarchy of zones, and the cost table at a node may include zones at different levels of the hierarchy.

4.8 Link Costs and Delay Computation

Other measurements of received signals can be used as the basis for computing link costs. In CDMA systems, the signal correlation values can be used instead of a direct measurement of signal-to-noise ratio. Similarly, an absolute signal level can alternatively be used. Digital error rates, such as bit or packet error rates, can also be used as the basis for determining link costs.

An alternative approach uses costs that are based on other factors than signal quality. For example, transmissions from a power-limited node may have a higher cost than similar transmissions from a node that is not power limited. In this way, packets are preferentially routed away from power-limited nodes. Other measures of link reliability can also be used. For example, if a link is known to be periodically unavailable or known to be unreliable, its link cost can be set higher than a continuously available link.

In the approaches described above, packet retransmission is typically delayed, in part to avoid unnecessary retransmissions or to avoid collisions. Alternative approaches can be used to compute the amount to delay a packet. For instance, a deterministic rather than random delay can be used. Also, the delay or its probability distribution can be based on factors such as the absolute cost to reach the destination, a next-link cost to the destination, a geographic distance of the last link or of the distance to the destination, available power at the node, pre-configured parameters such as parameters related to the desirability of forwarding packets, or characteristics of the packet such as a priority,

4.9 Combination with Other Routing Approaches

The gradient routing approach described above can alternatively be combined with explicit routing. For example, unicast packets can be explicitly addressed to a next node on the shortest path to the destination, and a receiving node that is explicitly addressed in this way then forwards the packet without delay. Because only one node is explicitly addressed in this way, multiple nodes will not immediately forward the node and therefore immediate collisions are avoided.

In this approach, nodes that receive the packet but that are not explicitly addressed act as backups to the node on the shortest path. Should the explicitly addressed node on the shortest path fail to forward the packet, these nodes that act as backups will forward the packet to make up for the addressed node's failure to forward the packet.

5 Automatic Assignment of Identification Number

Upon joining a network, a node acquires a node identification (NID) number. The size of the NID number is chosen according to the potential size of a network. In this example, the NID number is a sixteen-bit number providing 65536 different NID numbers.

In some implementations, the network attempts to assign a unique NID number to each node in the network. For example, a node that selects an NID number to assign to itself or to another node broadcasts the selected NID number to the rest of the nodes in the network to determine whether that NID number is currently in use by another active node in the network.

In other implementations, if the network routes packets out to a maximum number of hops (e.g., 10 hops), it is sufficient that NID numbers be unique out to twice as many hops (i.e., 20 hops). No node will then be within range of two nodes with the same NID number.

Upon joining a network, a node may acquire an NID number that is not currently in use by any active node in the network. However, since networks may be built piecemeal by connecting previously separated networks, conflicts can arise between previously separated nodes. So the nodes monitor identification information that is based on received messages (e.g., packets) to detect conflicting nodes (e.g., two or more nodes having the same NID number). For example, each node maintains a list of at least a portion of the NID numbers for other nodes based on packets received from neighboring nodes. Nodes monitor their lists for a conflict or potential conflict between nodes.

A conflict between nodes having the same NID number may cause a node to misdirect a packet. If nodes A and B have the same NID then a third node C may forward a packet intended for node A to node B instead. The probability of this type of error occurring is reduced by each node monitoring for the same NID number being associated with two or more nodes. If a conflict is detected, one or more of the conflicting nodes can be notified to select a new NID number.

If a conflict is not detected by a node, an error caused by the conflict (e.g., a misdirected packet) is handled by a higher layer in the protocol stack. For example, if a packet does not reach its intended destination due to a conflict, the packet will not be acknowledged back to the sender. The sender will eventually reinitiate certain communication functions (e.g., node discovery and route creation), which provide another chance to detect the conflict.

5.1 Self-Selection Approach

5.1.1 Selection

In one approach, a node joining a network selects a random 16-bit number as its NID number (e.g., using any of a variety of algorithms for generating a pseudorandom number). The joining node broadcasts its selected NID number out to nodes within a routing domain (e.g., twice the maximum number of hops in a route). If another node receives the “NID selection broadcast” and is already using the selected NID number, that node will report the conflict back to the joining node, pick a new NID number itself, or both. If the joining node does not receive a report of a conflict within a predetermined amount of time, the joining node uses the selected NID number.

5.1.2 Conflict Detection

After joining a network, a node may still conflict with another node. If a conflicting node is not active (e.g., in an idle state, turned off, or not currently connected to the network), the conflicting node will not receive an NID selection broadcast and therefore will not report the conflict. The conflict can be detected by having each node include in each update packet (i.e., a packet flagged to update cost tables) an 8-bit “verification tag” that is derived from a local source (e.g., an 64-bit IEEE EUI-64™ or a 48-bit MAC address). For example, a 64-bit EUI-64™ number can be divided into an array of 16 4-bit nibbles. A random 4-bit number is chosen to select a corresponding one of the 16 nibbles. An 8-bit verification tag is made up from the random 4-bit number and the selected 4-bit nibble. That verification tag is then included in each update packet.

Each node augments its cost table 120 to store verification tags along with NID numbers to detect conflicts. When a node receives an update packet, if there is currently no entry in the node's cost table for the source node, then the receiving node enters the verification tag into the cost table along with the NID number and updated cost. If there is an entry in the node's cost table for the source node, then the receiving node compares the verification tag in the update packet with the verification tag in the cost table entry for the source node. If the verification tags do not match, then the receiving node reports a conflict to one or both of the nodes to select a new NID number. (If the verification tags do match, there is no conflict with high probability.) Since verification tags are only sent in update packets, the verification tag does not add substantial overhead to network traffic. Conflicts are detected with high probability by any node that receives update packets from two different nodes using the same NID.

In an alternative implementation, since conflicts can be detected by nodes monitoring identification information in their cost tables, the initial NID selection broadcast does not need to be performed.

5.2 Identification Authority Approach

5.2.1 Selection

In another approach, a node can become an identification authority to select and assign unique NID numbers to itself and other nodes. Upon joining a network, a node attempts to acquire a NID number by advertising locally (e.g., by broadcasting within a predetermined number of hops) for an identification authority that can supply one. If no identification authority is found, the node attempts to become an identification authority itself.

A node can become an identification authority by selecting a random (fixed-sized) block of NID numbers and an associated random “authentication tag,” broadcasting its intent of using the block of NID numbers, and then waiting for objections. For example, if the block size is 64, each NID number consists of a ten-bit prefix that is randomly chosen by the identification authority, and a six-bit suffix that is allocated (e.g., in ascending order) to a particular node that requests a NID number from that identification authority. The authentication tag can be longer than the prefix (e.g., 64 bits) to reduce the probability of “authority collisions” (e.g., two previously separated nodes selecting the same prefix and authentication tag) without generating substantial overhead traffic on the network (since the full authentication tag is not included in every packet).

If the selected prefix (i.e., block of NID numbers) are in use by another identification authority, then a node will object (e.g., by sending a packet in reply to the broadcast). The node attempting to acquire a NID number can then advertise again for an identification authority (in case another node has recently become one) and/or select a new prefix to use and re-broadcast its intent to become an identification authority with the new prefix.

If there are no objections within a predetermined time limit, then the node becomes an identification authority and can assign NID numbers from the selected block (including one for itself). Along with a unique NID number, an identification authority transmits to a requesting node (e.g., in a unicast packet) the authentication tag associated with that identification authority. Each node stores its NID number and the associated authentication tag in nonvolatile memory (e.g., an EEPROM). After the block of NID numbers is exhausted the node is no longer an identification authority.

Another way that a node uses the authentication tag to ensure that the node's NID number is still “valid” when the node becomes active after a period of inactivity (e.g., after waking from a “sleeping” state, or after a reboot). This is done by advertising locally for a node having a valid NID number from the same block (i.e., having the same prefix and the same authentication tag). As long as at least one node from the block has remained active (and listening for conflict reports), a node from that block will be able to successfully re-verify its NID number. This validity check ensures that any conflict report would have been heard by at least one node with an NID number from the same identification authority.

5.2.2 Conflict Detection

Conflicts can be detected by storing a “conflict table” of prefixes and their associated authentication tags at each node. Selected nodes (e.g., all nodes, or only identification authorities) include in each update packet their prefix and authentication tag, or, to reduce memory usage and/or overhead traffic, a portion of their authentication tag. For example, each entry in the conflict table includes shortened authentication tag made up from one byte from the 8-byte authentication tag and the (3-bit) index of that byte within the authentication tag.

With 64-bit authentication tags a conflict table entry fits in three bytes: a ten-bit NID number prefix, a three-bit index into the full authentication tag, eight bits of the full identification tag, and three bits left over (e.g., for aging, longer prefixes, etc.). The conflict table can have a predetermined maximum size (e.g., 4 or 8 entries) and entries can be replaced at random as update packets corresponding to new identification authorities arrive.

When a node receives an update packet, if there is currently no entry in the node's conflict table for the prefix in the update packet, then the receiving node enters the prefix and shortened authentication tag into the conflict table (and the NID number and updated cost into the conflict table). If there is an entry in the node's conflict table for the prefix, then the receiving node compares the shortened authentication tag in the update packet with the shortened tag in the conflict table entry for the prefix. If the shortened authentication tags do not match, then the receiving node reports a conflict to one or both of the identification authorities to select and assign new NID numbers to any nodes in its block.

A node that receives update packets from two nodes with the same prefix derived from different authorities will detect the conflict unless: neither prefix is saved in its table, or the shortened authentication tags happen to match even though the full authentication tags do not. The size of the shortened authentication tags and the size of the conflict table are selected to make the probability of detecting a conflict high. A conflict is detected even if only one node in the network detects a conflict between prefixes potentially used by different blocks of nodes. In this approach, a conflict may be detected even if no two nodes in the network are assigned the exact same NID number.

5.3 Mobile Nodes

Assignment of identification numbers for mobile nodes (e.g., handheld configuration devices) can be handled differently to avoid potential problems associated with movement of such nodes. One approach is to reserve a subset of the NID numbers for mobile nodes and assign the NID numbers using a different protocol (e.g., manually). Alternatively, mobile nodes can periodically reaffirm that their NID number is unique by broadcasting a message similar to the NID selection broadcast described above.

It is to be understood that the foregoing description is intended to illustrate and not to limit the scope of the invention, which is defined by the scope of the appended claims. Other embodiments are within the scope of the following claims.

1. A method for identifying nodes in a network, comprising:
selecting identification parameters for nodes in the network;
at some nodes in the network,
maintaining identification information for a plurality of nodes based on messages received from neighboring nodes; and
monitoring the identification information for a conflict between two or more nodes.

2. The method of claim 1 wherein selecting identification parameters comprises:
generating a random number at a first node in the network;
broadcasting the random number to a plurality of nodes in the network; and
selecting the identification parameter based on the random number.

3. The method of claim 2 further comprising receiving the broadcast random number, and reporting a conflict if the broadcast random number is already in use.

4. The method of claim 1 wherein selecting identification parameters comprises:
generating a random number at a first node in the network;
sending a request message from a second node in the network to the first node;
selecting the identification parameter based on the random number in response to the request message; and
sending the identification parameter from the first node to the second node.

5. The method of claim 4 wherein selecting the identification parameter based on the random number comprises using the random number as a prefix for the identification parameter.

6. The method of claim 1 wherein maintaining identification information based on messages received from neighboring nodes comprises:
receiving a message from a neighboring node, the message originating from an origin node; and
storing an identification parameter for the origin node along with a tag included in the message.

7. The method of claim 6 wherein the tag is derived from a source local to the origin node.

8. The method of claim 6 wherein the tag is randomly selected.

9. The method of claim 1 wherein monitoring the identification information for a conflict between two or more nodes comprises:
receiving a message from a neighboring node, the message originating from an origin node;
matching an identification parameter for the origin node to a stored identification parameter;
comparing a tag included in the message with a stored tag associated with the stored identification parameter; and
reporting a conflict if tags do not match.

10. The method of claim 9 wherein the wherein the tag is derived from a source local to the origin node.

11. The method of claim 9 wherein the tag is randomly selected.

12. Software stored on a computer-readable medium for identifying nodes in a network, comprising instructions for causing a processor to:
select identification parameters for nodes in the network;
at some nodes in the network,
maintain identification information for a plurality of nodes based on messages received from neighboring nodes; and
monitor the identification information for a conflict between two or more nodes.

13. The software of claim 12 wherein selecting identification parameters comprises:
generating a random number at a first node in the network;
broadcasting the random number to a plurality of nodes in the network; and
selecting the identification parameter based on the random number.

14. The software of claim 12 wherein selecting identification parameters comprises:
generating a random number at a first node in the network;
sending a request message from a second node in the network to the first node;
selecting the identification parameter based on the random number in response to the request message; and
sending the identification parameter from the first node to the second node.

15. A node in a network, comprising:
a memory for storing identification parameters for nodes in the network; and
a controller configured to
select an identification parameter;
maintain identification information for a plurality of nodes based on messages received from neighboring nodes; and
monitor the identification information for a conflict between two or more nodes.

16. The node of claim 15 wherein selecting the identification parameter comprises:
generating a random number;
broadcasting the random number to a plurality of nodes in the network; and
selecting the identification parameter based on the random number.

17. The node of claim 15 wherein selecting the identification parameter comprises:
generating a random number;
receiving a request message from a node in the network requesting an identification parameter;
selecting the identification parameter based on the random number in response to the request message; and
sending the identification parameter to the requesting node.
